(19) United States
(12) Patent Application Publication
(10) Pub. No.: US 2015/0255189 A1
(43) Pub. Date: Sep. 10, 2015

(54) CABLE COMPRISING A PTFE COATING

(71) Applicant: Produits Plastiques Performants Holding-3P Holding, Dardilly Cedex (FR)

(72) Inventor: Emmanuel Garraud, Langres (FR)

(21) Appl. No.: 14/437,705

(22) PCT Filed: Oct. 29, 2013
(86) PCT No.: PCT/FR2013/052589

§ 371 Date: Apr. 22, 2015

(30) Foreign Application Priority Data
Oct. 29, 2012 (FR) 1260306

(51) Int. Cl. H01B 3/44; H01B 13/08

(52) U.S. Cl. CPC H01B 3/445; H01B 13/0883; H01B 13/0891

(57) ABSTRACT

A cable having one or more cores coated in a coating comprising at least one layer (a) of a material based on polytetrafluoroethylene (PTFE) with 5% to 80% by weight filler, and at least one layer (b) of a material based on PTFE with less than 8% by weight filler, the layer (b) being positioned outside the layer (a), and also a method of preparing the cable and a kit for constructing the cable.

### CROSS-REFERENCE TO RELATED APPLICATIONS

This application is the U.S. National Phase application of PCT Application No. PCT/FR2013/052589 filed Oct. 29, 2013, which claims priority to the French application 1260306 filed on Oct. 29, 2012, which applications are incorporated herein by reference and made a part hereof.

### BACKGROUND OF THE INVENTION

1. Field of the Invention

The present invention relates to a cable, in particular an electric cable, comprising a core coated in a coating material of the polytetrafluoroethylene (PTFE) type, having a large amount of filler, and the invention also relates to a method of fabricating it.

2. Description of the Related Art

In order to improve the performance of conductive or non-conductive cables that include a thermal, electrical, or other coating, it is possible to impart special properties to the coating, e.g. leading to better resistance to heat or better mechanical strength.

It is thus known that adding a filler to the coating gives the coating and the cable it covers improved thermal resistance, mechanical strength, and/or electrical insulation, where a filler is a solid substance that is added to a matrix (i.e. a material suitable for being used as a coating, such as a PTFE-based material), which material is preferably in the form of particles or fibers of small dimensions that are immiscible with the matrix and that are dispersed within the matrix by mechanical means. The solid substance or filler may be constituted by a wide variety of materials depending on the effect that is to be obtained. For example, it may comprise glass fibers, carbon, ceramic particles, etc. In particular, Document GB 763 761 describes a coaxial cable having two homogeneous semiconductor layers comprising PTFE and carbon (in the range 15% to 60% by weight), these layers being separated by a dielectric layer based on PTFE. Document U.S. Pat. No. 3,176,065 describes a cable comprising two homogeneous layers of PTFE and a layer made up of PTFE (50% to 90% by weight) and of alumina (10% to 50% by weight).

Furthermore, in the field of electric cables, an enrichment in metal oxide, in particular in organometallic compounds, serves to reduce the corona effect, which is an undesirable effect that can be observed in particular in the field of aviation.

Nevertheless, insulating cables by means of filled PTFE materials raises serious difficulties due to the presence of a large quantity of filler within the PTFE which is very difficult to make compatible with methods for extruding the material.

There therefore exists a need for a cable coated in a PTFE-based coating that includes a filler and that presents properties that are improved in terms of thermal resistance, mechanical strength, and/or electrical insulation, and that is also capable under certain conditions of effectively reducing the corona effect.

### SUMMARY OF THE INVENTION AND DETAILED DESCRIPTION OF THE PREFERRED EMBODIMENTS

To this end, the invention provides a cable having one or more cores coated in a coating comprising:
at least one layer (a) of a material based on polytetrafluoroethylene (PTFE) with 5% to 80% by weight of a filler; and
at least one layer (b) of a material based on PTFE having no filler or filled with less than 8% by weight of a filler;

the layer (b) being positioned outside the layer (a).

When the PTFE-based material has a filler of less than 8% by weight, that means that a filler is present and that the quantity of filler is necessarily not zero. Thus, the percentage of the filler lies in the range [0, 8], with 0 and 8 being excluded from the range. Advantageously, that means that the filler constitutes 1%, 2%, 3%, 4%, 5%, 6%, or 7% by weight.

Filler content is expressed as a percentage relative to the total weight of the PTFE-based material constituting the layer in question.

The invention thus proposes superposing at least one layer (a) and at least one layer (b), this superposition of layers making it possible to obtain a coating having a large amount of filler, while avoiding the working problems associated with manipulating such PTFE-based compositions, and in particular those relating to extrusion and poor mechanical cohesion. The advantageous effects on thermal resistance, mechanical strength, and/or electrical insulation, such as for example reducing the corona effect, are greater when the coating presents a large amount of filler. This succession of layers having different amounts of filler serves in particularly advantageous manner to obtain a coating that presents an overall quantity of filler that is substantially equivalent to the sum of the quantities of filler in each of the layers. Also, such cables comprising a succession of filled layers advantageously present thermal resistance, mechanical strength, and/or electrical insulation that are better than those presented by a smaller amount of filler and/or an amount of filler that is limited by preparation methods.

The term “core” is used to designate a strand or a rod that may be cylindrical in shape. The core is preferably made of metal, and is thus generally conductive, in particular electrically conductive. It may be a strand of copper or of aluminum having a diameter of a few millimeters. It may be treated with silver in order to improve conductivity.

A single cable may have one or more cores. The or each core may be surrounded by a polyimide film, e.g. of the Kapton® (Dupont) type. Such a film may be in direct contact with the core of the cable. When implementing the invention, there is thus no need to have a layer of filled PTFE-based material directly in contact with the core of the cable. In the same manner, there is no need for the layers (a) and (b) to be in direct contact, although that it is a preferred aspect of the invention.

The term “coating” is used to mean covering an element, advantageously as a whole, or over a major portion (e.g. more than 95% of the surface for coating). For an element that is generally cylindrical in shape, such as a cable, the term “as a whole” designates the cylindrical surface and not necessarily the ends of the cable.

Preferably, the coating as a whole, and/or in at least one of the layers (a) and/or (b) making it up, is insulating.

The term “insulating” is used to mean any material, such as a PTFE-based material, that limits energy exchanges between two systems. This term covers materials that are electrically insulating, thermally insulating, sound insulating, and/or mechanically insulating.

The material based on “polytetrafluoroethylene” or “PTFE” comprises at least 50% by weight of PTFE which is modified or not modified, preferably at least 75% by weight of modified or non-modified PTFE, and even more preferably consists essentially of modified or non-modified PTFE, i.e. comprises at least 90% modified or non-modified PTFE. Thus, the PTFE-based material may be constituted by PTFE, modified or not modified. The filler is not included in this definition of a PTFE-based material.

PTFE is a polymer comprising a carbon chain with atoms of fluorine in its formulation and essentially consisting in (—CF₂—CF₂—)ₙ motifs.

Modified PTFE is constituted by PTFE chains in which fluorine atoms are replaced by oxygen atoms that present branching PTFE chains. Thus, modified PTFE may comprise motifs of the following type:

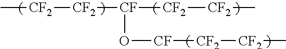

Advantageously, the material of the outer layer (b) is made of modified PTFE, since modified PTFE thus provides better cohesion between the various layers.

The modified or non-modified PTFE may adopt a typical specific gravity, i.e. specific gravity lying for example in the range 1.45 to 1.70 for raw PTFE and 1.5 to 4 for cured PTFE.

The coating of the cable may thus comprise one or more layers (a) and one or more layers (b). These layers may be organized in strata or in laminated layers in the thickness of the insulation in various ways.

For example, a layer (c) of a PTFE-based material having no filler or less than 8% by weight of a filler may be positioned under the layer (a). This layer may be placed optionally directly in contact with one or more cores of the cable. Such an additional layer (c) may thus be covered by a layer (a) arranged outside the layer (c). Such a layer (c) may be constituted by a material that is identical to that of the layer (b) or that is different therefrom.

Thus, as described in detail below, the layer (b) and/or (c) may be obtained by co-extrusion of the PTFE-based material or by winding a preferably raw tape around the core(s) of the cable.

Preferably, at least the filler of the material of the layer (a) comprises a compound selected from the group constituted by metal oxides, glass fibers, carbon, ceramics, and mixtures thereof. Advantageously, the compound comprises at least one metal oxide.

The term “metal oxide” is used more particularly to mean oxides of alkaline earth metals, of transition metals, and of poor metals. Advantageously, the metal oxide is selected from the group constituted by titanium dioxide, alumina, zinc oxide, copper oxide, magnesium oxide, and silver oxide, and mixtures thereof.

Preferably, the filler of the material of the layer (a) comprises a single metal oxide, selected from the above-specified group. The layer (a) and the layer (b) may be filled with compounds that are identical or different, e.g. alumina for the layer (a) and zinc/titanium oxide for the layer (b). Advantageously, the filler content of the material of the layer (a) constitutes 15% to 60%, preferably 25% to 55%, more preferably 50% by weight of the PTFE-based material.

Advantageously, the PTFE-based material of the layer (b) (or possibly of the layer (c)) is filled with less than 7%, preferably less than 5% by weight of the PTFE-based material of the layer in question.

The layer (b), and/or optionally (c), is advantageously obtained by lubricated extrusion. The PTFE-based material constituting such a layer thus advantageously includes pigments. It may also contain traces of lubricant and/or of wetting agent.

Preferably, the layer(s) of PTFE-based material having no filler, such as the layer (c), or having less than 8% by weight of filler, such as (b), comprises modified PTFE. Preferably, the PTFE is modified PTFE.

Advantageously, the invention also provides a cable as defined above, wherein the PTFE-based material of the layer (b) and/or of the layer (c) comprises modified PTFE.

Advantageously, the invention provides a cable as defined above, in which the PTFE-based material of the layer (b) and/or of the layer (c) includes pigments. Advantageously, the layers (a), (b), and/or possibly (c), are homogeneous. The term “homogeneous ” is used to mean a layer that is continuous without break, e.g. without any space, gap, or hole in the material.

When the PTFE material of the layer (b), or possibly of the layer (c), is co-extruded, the layer may nevertheless not be homogeneous.

According to a particular aspect of the invention, the cable may include an additional outer coating covering the layers (a) and (b), e.g. an elastomer coating.

The invention also provides a fabrication method for fabricating a cable having one or more cores coated in a coating, the method comprising:
a step (i) of winding a first tape having a width and being made of a cured PTFE-based material including 5% to 80% by weight of filler, around the core(s) in order to obtain an intermediate cable; and
a subsequent step (ii) of coating the intermediate cable with a material based on raw PTFE including no filler or less than 8% by weight filler.

Filler contents are expressed as percentages relative to the total weight of the tape or the PTFE-based material used. The PTFE-based materials and the fillers used, which may be identical or different, are as described above. Nevertheless, PTFE-based materials that can be extruded, in particular those in which the filler content is less than 8% by weight, may include agents such as lubricants or wetting agents. Such agents generally evaporate off during subsequent steps in the fabrication method. The lubricant is then preferably a hydrocarbon-based liquid, such as an isoparaffinic hydrocarbon, in particular Isopar™, and the wetting agent is a fatty alcohol, advantageously dodecan-1-ol. The wetting agent enables better miscibility of the PTFE with fillers and thus encourages the formation of a mixture that is homogeneous. Isopar™ (Exxon Mobile Chemical) is a mixture of high purity synthetic isoparaffinic hydrocarbons.

This method makes it possible to use a combination of cured and raw tapes imparting effects that are particularly advantageous on the thermal resistance, mechanical strength, and/or electrical insulation of the cable obtained in this way.

A material based on raw PTFE is not subjected to a sintering cycle during its fabrication method (i.e. it is exposed to temperatures of less than 350° C.) and its specific gravity generally lies in the range 1.45 to 1.70.

The tape based on cured PTFE is then subjected during its fabrication method to a sintering cycle (i.e. it is exposed to a temperature higher than 350° C. for several minutes or several hours), and its specific gravity then generally lies in the range 1.5 to 4, e.g. being 2.16.

Advantageously, a preliminary step is performed before the step (i), the step comprising coating the core, or cores, with a raw PTFE-based material having no filler or less than 8% by weight of filler.

In a particular aspect of the invention, the coating step (ii) is performed by winding a second tape around the intermediate cable.

Advantageously, the method also includes a subsequent step (iii) of curing the cable, preferably at a temperature higher than 350° C., more particularly at a maximum temperature of 450° C. This step serves advantageously to achieve better weldability between the cured rotary cut strip and the raw tape, and more generally provides better overall cohesion of the coating obtained in this way. These aspects are even more advantageous when the material used in step (ii) is based on modified PTFE.

Advantageously, the method also includes an additional step of coating the cable in an additional coating, e.g. an elastomer coating.

Advantageously, the tape(s) is/are of thickness lying in the range 20 micrometers (μm) to 250 μm, preferably in the range 40 μm to 140 μm, e.g. in the range 70 μm to 80 μm.

The thicknesses of the tapes are mutually independent. According to a particular aspect of the invention, the first tape is wound around the core with overlap on or around itself. This overlap may lie in the range 0.1% to 100%, and preferably may be 50%, 75%, 33%, or 25%; these percentages being expressed relative to the width of the tape.

The invention also provides a kit for fabricating a cable as described above, the kit comprising:
at least one core;
at least one tape of cured PTFE-based material having 5% to 80% by weight of a filler; and
at least one tape of raw PTFE-based material with no filler or with less than 8% by weight of filler.

The filler contents are expressed as percentages relative to the total weight of the PTFE-based material constituting the tape.

The cured and raw PTFE-based materials are preferably as described above.

The present invention also provides the use of a cable of the invention or fabricated by a method or from a kit of the invention in the fabrication of an electric circuit, an electric circuit for aviation.

The invention is not limited to the embodiments and implementations presented, and others will appear clearly to the person skilled in the art. For example, a coating of the invention may be applied to an element or a device other than a cable. The invention can be better understood on reading the examples that are described by way of indication and that are not limiting on the invention.

### EXAMPLE 1

### Fabricating a Cable of the Invention Having Two Layers Based on Filled PTFE

In a preferred embodiment, a cable of the invention is obtained by winding strips of cured and raw PTFE including fillers. The composition of the strips is selected in such a manner as to obtain different layers of fillers around the core of the cable. These strips are wound around the core, and then the cable as obtained in this way is subjected to a curing step. This step serves in particular to bond the various layers together.

Commercially available cured tapes are obtained using methods that are well known. In short, PTFE powder, possibly together with other ingredients making up the tape, such as pigments, is mixed with the selected filler. The mixture is molded under pressure. This compacting step may typically be carried out at a pressure lying in the range 30 bars to 700 bars. The blank produced by this molding step is then cured. The curing step consists in a heating cycle that may go from a few hours to several days at a dwell temperature higher than 345° C., typically of 375° C. The block as obtained in that way is transformed into films by the technique known as rotary cutting.

For tapes made of raw PTFE, the fabrication method is also known. By way of example, it is described in the patent application published under the number WO 2012/001313. In summary, a mixture of PTFE, which is generally accompanied by other ingredients such as lubricant and pigments, and of the filler is pre-formed by compacting (molding at low pressure) and then the preforms are extruded. The resulting extrusion is calendared in order to obtain a film of desired thickness, typically 76 μm. A low temperature heating step serves to evaporate off the lubricant which is generally present since it makes it possible to perform the extrusion step.

Various filled cured tapes can be used in the method of the invention for taping one or more cores are listed in the table below:

| | | Filler (% metal oxide relative |
|---|---|---|
| | Thickness in μm | to total weight of PTFE) |
| 1 | 80 | 60% bronze |
| 2 | 65 | 15% alumina |
| 3 | 65 | 25% glass fiber |
| 4 | 100 | 15% carbon |
| 5 | 80 | 25% alumina |

A particular example was made using a cured tape that had been obtained using the following method: standard PTFE filled with 15% alumina obtainable from the supplier 3M Dyneon was molded into the form of a hollow cylinder having a height of 200 millimeters (mm) with an inside diameter of 76 μm and an outside diameter of 197 mm. A pressure of 65 bars was applied for 5 minutes (min). The blank was then cured for 12 hours (h) at 370° C. After cooling, the blank was subjected to rotary cutting on a rotary cutting machine to produce a film having thickness of 80 μm and width of 15 mm. The tape was wound manually around an aluminum core having a diameter of 6 mm. Winding was performed helically with an offset leading to the tape overlapping itself over 50% of the width of the tape.

A raw PTFE tape having thickness of 76 μm and no filler, width of 12 mm, and a blue color, sold under the trademark 3P, reference PTFE E76, L12 BLEU tape by the supplier 3P France (BP 79161, 95075 Cergy Pontoise cedex, France) was wound manually around the core together with the tape having 15% alumina filler. Winding was performed helically with an offset leading to the tape overlapping itself by 50% of the width of the tape. The cable as taped in that way was cured for 7 min at 360° C. The cable remained intact, it did not explode during curing, and the two layers of filled PTFE presented good adhesion with each other.

For the winding step, it is possible to use winding machines, such as those sold by the Italian supplier W.T.M. S.r.l. of Padova, Italy (www.wtmachinery.com).

The thermal resistance of the cable obtained in Example 1 has been studied. For this purpose, cables were maintained for 50 h at a temperature of 360° C. The state of their overall structure was then observed with the naked eye, i.e. a search was made for the presence or absence of deterioration in their external structure. It was observed that the cable presented no holes visible to the naked eye. Furthermore, both layers of insulation (80 μm PTFE tape with 15% alumina filler and blue 76 μm tape) did not separate, neither from each other nor from the metal core.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A cable having one or more cores coated in a coating comprising:
at least one layer (a) of a material based on polytetrafluoroethylene (PTFE) with 5% to 80% by weight filler; and
at least one layer (b) of a material based on PTFE with less than 8% by weight filler;
said at least one layer (b) being positioned outside said at least one layer (a), and said filler contents being expressed as a percentage relative to a total weight of said PTFE-based material.

2. The cable according to claim 1, wherein said filler content of said material of said at least one layer (a) constitutes 15% to 60%, preferably 25% to 55%, more preferably 50% by weight of said PTFE-based material.

3. The cable according to claim 1, further comprising a layer (c) of PTFE-based material having no filler or less than 8% by weight filler, said layer (c) being positioned under said at least one layer (a).

4. The cable according to claim 1, wherein at least said filler of said material of said at least one layer (a) comprises a compound selected from a group constituted by metal oxides, glass fibers, carbon, ceramics, and mixtures thereof.

5. The cable according to claim 4, wherein said compound comprises at least one metal oxide selected from a group constituted by titanium dioxide, alumina, zinc oxide, copper oxide, magnesium oxide, and silver oxide, and mixtures thereof.

6. The cable according to claim 5, wherein said filler of said PTFE-based material of said at least one layer (a) comprises a single metal oxide.

7. The cable according to claim 1, wherein said PTFE-based material of said at least one layer (b) and/or of said layer (c) comprises modified PTFE.

8. The cable according to claim 1, wherein said PTFE-based material of said at least one layer (b) and/or of said layer (c) further comprises pigments.

9. The cable according to claim 1, wherein said at least one layers are homogeneous.

10. The cable according to claim 1, further including an additional outer coating covering said at least one layers (a) and (b).

11. A fabrication method for fabricating a cable having one or more cores coated in a coating, the method comprising:
a step (i) of winding a first tape having a width and being made of a cured PTFE-based material including 5% to 80% by weight of filler, around said one or more core(s) in order to obtain an intermediate cable; and
a subsequent step (ii) of coating said intermediate cable with a material based on raw PTFE including no filler or less than 8% by weight filler;
said filler contents being expressed as a percentage relative to a total weight of said first tape or the PTFE-based material.

12. The fabrication method according to claim 11, wherein said filler of said first tape constitutes 15% to 60%, preferably 25% to 55%, more preferably 50% by weight of said PTFE-based material.

13. The fabrication method according to claim 11, wherein a preliminary step is performed prior to step (i), said step comprising coating said one or more cores with a raw PTFE-based material including no filler or less than 8% by weight filler.

14. The fabrication method according to claim 11, wherein said coating step (ii) is performed by winding a second tape around said intermediate cable.

15. The fabrication method according to claim 11, further including a subsequent step (iii) of curing said intermediate cable.

16. The fabrication method according to claim 11, further including an additional step of coating said intermediate cable in order to constitute an additional coating.

17. The method according to claim 11, wherein said PTFE-based material of said first tape is filled with a metal oxide selected from a group constituted by titanium dioxide, alumina, zinc oxide, copper oxide, magnesium oxide, and silver oxide.

18. The method according to claim 14, wherein said first tape or said second tape used present(s) a thickness lying in a range 20 μm to 250 μm.

19. The method according to claim 18, wherein said thickness lies in a range 40 μm to 140 μm.

20. A kit for fabricating a cable according to claim 1, the kit comprising:
at least one core;
at least one tape of cured PTFE-based material having 5% to 80% by weight of filler; and
at least one tape of raw PTFE-based material having less than 8% by weight filler;
said filler contents being expressed as percentages relative to a total weight of said PTFE-based material constituting said at least one tape.

21. A The kit according to claim 20, wherein said filler content of said at least one tape made of cured PTFE-based material having 5% to 80% by weight of filler lies in a range 15% to 60%, preferably in a range 25% to 55%, more preferably 50% of a weight of the PTFE-based material.

22. The use of a cable in the fabrication of an electrical circuit for aviation purposes, said cable having one or more cores coated in a coating comprising:
at least one layer (a) of a material based on polytetrafluoroethylene (PTF) with 5% to 80% by weight filler; and
at least one layer (b) of a material based on PTFE with less than 8% by weight filler;
said at least one layer (b) being positioned outside said at least one layer (a), and said filler contents being expressed as a percentage relative to a total weight of said PTFE-based material;
wherein said cable could be fabricated by a fabrication method comprising:
a step (i) of winding a first tape having a width and being made of a cured PTFE-based material including 5% to 80% by weight of filler, around said one or more core(s) in order to obtain an intermediate cable; and
a subsequent step (ii) of coating said intermediate cable with a material based on raw PTFE including no filler or less than 8% by weight filler;
said filler contents being expressed as a percentage relative to a total weight of said first tape or the PTFE-based material;
wherein said cable could also be fabricated from a kit comprising:
at least one core;
at least one tape of cured PTFE-based material having 5% to 80% by weight of filler; and
at least one tape of raw PTFE-bused material having less than 8% by weight filler;
said filler contents being expressed as percentages relative to a total weight of said PTFE-based material constituting said at least one tape.

23. The cable according to claim 2, further comprising a layer (c) of PTFE-based material having no filler or less than 8% by weight filler, said layer (c) being positioned under said at least one layer (a).

24. The cable according to claim 3, wherein said PTFE-based material of said at least one layer (b) and/or of said layer (c) further comprises modified PTFE and/or pigments.

25. The fabrication method according to claim 12, wherein a preliminary step is performed prior to step (i), said step comprising coating said one or more cores with a raw PTFE-based material including no filler or less than 8% by weight filler.

26. The fabrication method according to claim 15, wherein said coating step (ii) is performed by winding a second tape around said intermediate cable.
